(19) United States
(12) Patent Application Publication
(10) Pub. No.: US 2022/0396344 A1
(43) Pub. Date: Dec. 15, 2022

(54) HYBRID BOAT

(71) Applicant: Knute G. Bidne, Chapin, SC (US)

(72) Inventor: Knute G. Bidne, Chapin, SC (US)

(21) Appl. No.: 17/484,424

(22) Filed: Sep. 24, 2021

Related U.S. Application Data
(60) Provisional application No. 63/209,629, filed on Jun. 11, 2021.

(51) Int. Cl. B63H 21/20; B63H 20/14

(52) U.S. Cl. CPC B63H 21/20; B63H 20/14; B63H 2021/205; B63H 2021/171

(57) ABSTRACT

An electric hybrid outboard engine for a traditional fuel-based outboard motor of a boat that can be retrofitted. The electric hybrid outboard engine includes a hybrid motor and a control unit. The hybrid motor can be switched between an active mode and a passive mode, the hybrid motor in the active mode acts as a motor to drive the propeller using electrical energy stored in a battery, and in the passive mode act as a generator configured to be driven by rotations of the shaft for charging the battery. The control unit can control the engaging and disengaging of the hybrid motor to the shaft and switching of the hybrid motor between the active mode and the passive mode.

### CROSS-REFERENCE TO RELATED APPLICATIONS

This application claims priority from the U.S. provisional patent application Ser. No. 63/209,629, filed on Jun. 11, 2021, which is incorporated herein by reference in its entirety.

### FIELD OF INVENTION

The present invention relates to a hybrid outboard motor for boats, and more particularly, the present invention relates to an electric hybrid outboard engine for fuel engine-based outboard motors that can be retrofitted.

### BACKGROUND

Recreational boats are generally powered with gasoline engines, either inboard or outboard. The outboard motors have certain advantages over inboard motors being portable. The gasoline-powered engines for boats are well proven and efficient. However, the gasoline engines for boats have a major drawback of causing both air pollution and noise pollution. Pollution, in general, has become a prime concern all over the world, causing global warming and health crises.

Research and development are underway for all-electric boats, however, to compete with gasoline engines, the electric engines require batteries typically above 24 volts. Without large battery banks, the ratio of power output to power input leaves the owner with short operating periods. This need for large battery storage also requires a costly battery management system. The complexity, power, and cost have been major roadblocks for the commercial success of all-electric vehicles. Thus, a need is there for a system that can take advantage of both gasoline engines and electric engines. A need is there for a system that is both energy efficient and reduces pollution caused by traditional gasoline engine-based boats.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an electric hybrid outboard engine for fuel-based boats.

It is another object of the present invention that the electric hybrid outboard engine can be retrofitted.

It is still another object of the present invention that the electric hybrid outboard engine can harness waste energy.

It is a further object of the present invention that the electric hybrid outboard engine can drive the boat using electric energy.

It is still a further object of the present invention that the electric hybrid outboard engine can be automatically engaged and disengaged.

In one aspect, disclosed is an electric hybrid outboard engine that can be retrofitted to a gasoline engine-based outboard motor. The disclosed electric hybrid outboard engine includes a dual-purpose brushless permanent magnet motor that can charge a battery in a passive mode and drive the shaft of a propeller in an active mode. In the passive mode, the hybrid motor can act as a generator harnessing energy from the propeller and shaft, wherein the mechanical energy can be used to charge the battery.

In one aspect, the disclosed electric hybrid outboard engine can further include a controller that can monitor the speed, position, and power requirements of the boat and can automatically switch the hybrid motor between the active mode and the passive mode.

In one aspect, the disclosed electric hybrid outboard engine can further include sensors to detect the location of the boat, boat direction, speed, proximity to other objects, and collision prevention system.

In one aspect, the disclosed electric hybrid outboard engine can further provide for autonomous steering in addition to built-in manual steering.

In one aspect, the electric hybrid outboard engine can also be connected to a solar panel for charging the battery.

In one aspect, the disclosed electric hybrid outboard engine can also include a digital dashboard that can present a range of information including boat speed, location, course, diagnostic information from the hybrid motor and other parts.

In one aspect, disclosed is an electric hybrid outboard engine for an outboard motor, the outboard motor can include a fuel engine and a shaft operably coupling the fuel engine to a propeller, the electric hybrid outboard engine can include a hybrid motor that is configured to switch between an active mode and a passive mode, the hybrid motor in the active mode acts as a motor configured to drive the propeller using electrical energy stored in a battery, and the hybrid motor in the passive mode act as a generator configured to be driven by rotation of the shaft for charging the battery; a transmission unit configured to operably couple the hybrid motor to the shaft; and a control unit operably coupled to the hybrid motor and the transmission unit, wherein the control unit can be configured to receive one or more parameters from one or more sensors, and based on the one or more parameters, engage and disengage the hybrid motor to the shaft, engage and disengage the fuel engine to the shaft, and switch the hybrid motor between the active mode and the passive mode.

In one implementation of the electric hybrid outboard engine the hybrid motor can be a brushless permanent magnet motor. The electric hybrid outboard engine can further include a shaft extension configured to couple the transmission unit to the propeller, wherein the transmission unit is configured to selectively drive the shaft extension by the hybrid motor or the fuel engine.

In one implementation of the electric hybrid outboard engine, the one or more sensors can include a speed sensor configured to detect a speed of a boat, wherein the control unit is configured to engage and disengage the hybrid motor to the shaft based on the speed of the boat. The one or more sensors further can further include a location sensor configured to detect a location of the boat, wherein the control unit is further configured to engage and disengage the hybrid motor to the shaft based on the location of the boat.

In one implementation of the electric hybrid outboard engine, the electric hybrid outboard engine further includes a solar panel that can be mounted to a roof of a boat and the control unit can charge the battery from renewable energy generated by the solar panel.

In one aspect, disclosed is an outboard motor for a boat, the outboard motor can include a fuel engine; a shaft operably coupled to the fuel engine; a propeller configured to be coupled to the shaft; the electric hybrid outboard engine; and a shaft extension operably coupling the transmission unit to the propeller, wherein the transmission unit is configured to selectively rotate the shaft by the hybrid motor or the fuel engine.

In one aspect, disclosed is a method for selectively propelling a boat using electricity or fuel, the boat includes an outboard motor, the outboard motor includes a fuel engine, a propeller, and a shaft operably coupling the fuel engine to the propeller, the method includes the steps of providing the electric hybrid outboard engine; mounting the hybrid motor and the transmission unit to the shaft; coupling a shaft extension to the transmission unit; and coupling the propeller to the shaft extension, wherein the transmission unit is configured to selectively rotate the shaft by the hybrid motor or the fuel engine. The method can further include the steps of receiving a speed of the boat from a speed sensor; comparing the speed of the boat with a threshold value; and upon comparison, engage the hybrid motor to the shaft and disengage the fuel engine from the shaft. The method can further include the steps of receiving a location of the boat from a location sensor; inquiring the location with a list of predetermined locations; and upon inquiring, engage the hybrid motor to the shaft and disengage the fuel engine from the shaft. The method can further include the steps of charging the battery from renewable energy generated by the solar panel.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a traditional boat having the disclosed electric hybrid outboard engine retrofitted, according to an exemplary embodiment of the present invention.

FIG. 2 is an exploded view of a hybrid motor, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is an electric hybrid outboard engine that can be used with traditional fuel engine-based outboard motors as an option to drive the boat using electrical energy stored in batteries. The disclosed electric hybrid outboard engine can be retrofitted in the outboard motors and allows automated switching between the electric and fuel options for driving the boat. The disclosed electric hybrid outboard engine can track the power usage of the boat and can efficiently charge the batteries. Moreover, the driving mechanism can be switched from fuel to electricity when the boat is driven at lower speeds to efficiently utilize the electrical energy and at the same time reduces fuel consumption and pollution.

The disclosed electric hybrid outboard engine can include a hybrid motor and a control unit. The hybrid motor can be dual purpose brushless permanent magnet motor that can act as a motor and a generator. As a motor, referred to herein as the active mode, the hybrid motor can drive the boat using electrical energy stored in the battery, while as a generator, also referred to herein as the passive mode, the hybrid motor can generate electricity for charging the battery. The controller can monitor the driving conditions of the boat, such as speed and position, and can switch the hybrid motor between the active mode and the passive mode. For example, when the battery is charged and the speed of the boat is low, the control unit can decouple the fuel-based engine and mechanically couple to the hybrid motor in the active mode to the shaft for driving the propeller. Similarly, when the battery charge levels are low, the hybrid motor can be switched to the passive mode, and the shaft driven by the fuel engine can drive the hybrid motor in generator mode for charging the batteries. It is to be understood that the controller can provide for automated switching of the hybrid motor between the active and passive modes, however, the same can also be done manually. Moreover, the parameters for automated switching of the hybrid motor can be programmed and reprogrammed as and when desired.

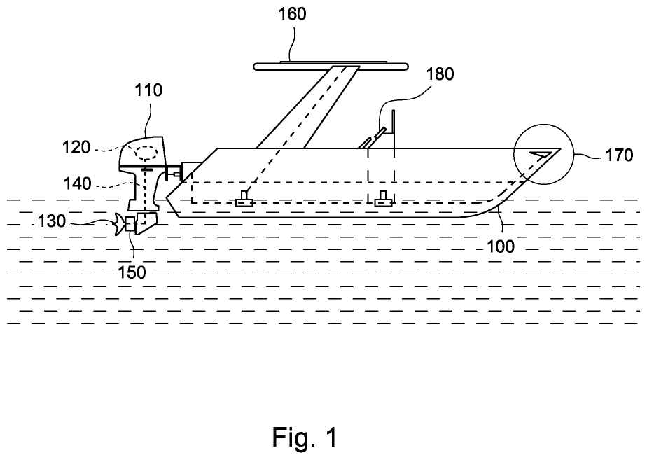

Referring to FIG. 1, which shows a traditional boat 100 having an outboard motor 110. The outboard motor 110 can have a fuel engine 120, such as a gasoline engine. The propeller 130 can be operably coupled to the fuel engine 120 through a transmission system which includes a shaft 140. The structure and functioning of the traditional fuel engine-based outboard motors including the transmission system are known to a skilled person and the disclosed electric hybrid outboard engine can be used with any such fuel engine outboard motors. The electric hybrid outboard engine can be retrofitted to the fuel engine-based outboard motors as shown in FIG. 1 without significant modifications. FIG. 1 shows the electric hybrid outboard engine 150 mounted at a lower point of the existing outboard motor 110 to the shaft 140. The existing propeller 130 and shaft 140 can be used making the installation cost-effective, quick, and easy.

The disclosed electric hybrid outboard engine can include a control unit (not shown) that controls the working of the electric hybrid outboard engine. The control unit can detect the different parameters such as speed of the boat, location, speed of fuel engine, distance to be travel, course, battery charge level, and like, and based on these parameters, the control unit can switch the hybrid motor between the active mode and the passive mode. For example, if the battery levels are low, the hybrid motor can be switched to passive mode, wherein the generator can be driven by the rotation of the shaft to generate electricity charging the batteries. In another case, if the boat is being driven at a low speed and the batteries are charged sufficiently, the control unit can switch the hybrid motor to the active mode. The control unit can also control engagement and disengagement of the hybrid motor and the fuel engine to the transmission. For example, the control unit can disengage the fuel engine from the transmission and engage the hybrid motor. Similarly, the control unit can engage the hybrid motor in the passive state to the shaft. It is to be understood that the hybrid motor can also be manually operated. For example, the user can manually switch from the fuel engine to the hybrid motor. In one case, the boat is going through an area wherein noise is restricted and not preferable. The user can manually switch to the hybrid motor despite the level of charge in the battery or speed of the boat. Similarly, the user can keep the hybrid motor disengaged and use only the fuel engine. The versatility provided by the disclosed electric hybrid outboard engine can provide for better commercial acceptance.

The disclosed electric hybrid outboard engine can also include solar panels 160 that can be mounted to the sides or roof of the boat and the control unit can also include suitable charging circuitry to charge the batteries using renewable energy generated by the solar panels. Additionally, the electric hybrid outboard engine can also include a range of sensors 170 that can determine the location, course, speed, distance from nearby objects, battery charge level, and like parameters. The information from the sensor can be used for switching the hybrid motor between active and passive modes, autonomous steering of the boat, and collision prevention, and coupling and decoupling of the hybrid motor and the fuel engine. Additionally, digital dashboards 180 can also be provided, wherein the information from the sensors can be displayed. The digital dashboard can replace the traditional dashboards.

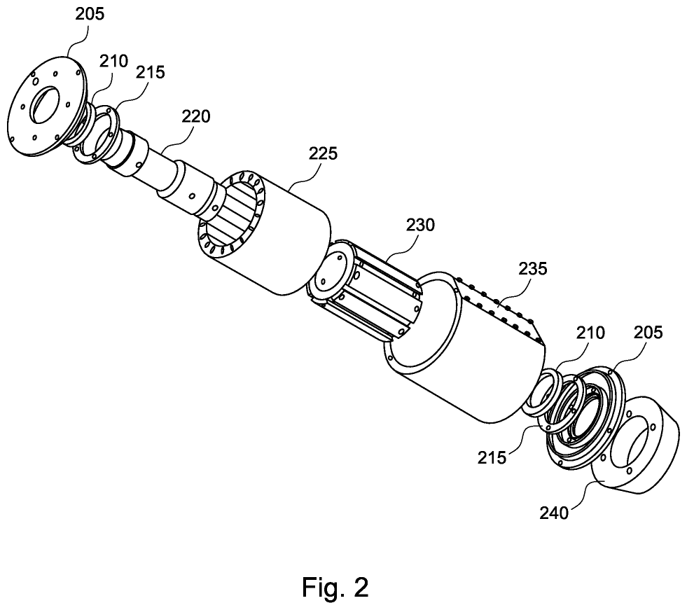

Referring to FIG. 2 which shows a transmission unit of the hybrid motor that can engage and disengage the hybrid motor to the shaft and for driving the shaft. For example, the hybrid motor can be mounted by first removing the propeller nut and propeller from the existing outboard engine shaft and sliding the hybrid motor onto the existing shaft. A new shaft extension can then be used to reassemble the propeller and nut thereby completing the conversion. FIG. 2 shows a front cover 205 that can be made of Aluminum Alloy 6061 and can also serve as the front and back cover of the hybrid motor. It can also house the two ceramic bearings 210 in the motor. The front cover may not be water-tight and during operation, it can allow some water to go inside the motor to keep it from overheating. The ceramic bearings may not be affected by seawater. The ceramic bearings can be Radial ball bearings and primarily allow loading forces in a radial fashion. They are not allowed and are not subjected to Axial forces in the motor. The bearing lock 215 can be a metal plate made of Aluminum 6061 Alloy and can be used to lock the bearings in the front cover. There can be two bearing locks in the hybrid motor. The rotor shaft 220 with splines can be a sleeve that can provide a connection between the motor rotor 230 and the outboard motor output shaft. It can be made of stainless steel 316 and can have internal splines to allow for torsion forces to be transmitted. The rotor 230 can be the main component of the hybrid motor and spins inside the motor when current is applied to the stator coils. The rotor core can be made of Magnetic silicone steel and can have 24 N42 neodymium magnets attached along the circumference with equal spacing. It can connect to the rotor shaft with splines by Allen bolts. Individual stator strips 225 can make up the stator of the hybrid motor and can be made of laminated Silicone magnetic steel sheets with 24 slots for copper coils. When current is applied to the stator it can concentrate the magnetic field produced by the copper coil and allows the motor to function efficiently. The casing 235 can be the outer frame of the hybrid motor and can be made of Aluminum 6061 Alloy. It can house the stator with copper coils. It can provide attaching points for the front covers of the motor and Prop front cone 240. The spline shaft can be the output shaft of the hybrid motor and connected to the rotor and also the rotor shaft with splines. Hence it can also be connected to the outboard motor output shaft. The spline shaft can also be the shaft where the propeller can be attached. It can have standard splines to allow for standard outboard propellers to be attached without any modification. The prop front cone 240 can be a cone made of Nylon or PLA plastic and its basic purpose can be to smoothen the flow around the motor and reduce drag. It can be installed on the back end of the motor with Allen bolts right next to the propeller. It is to be understood that FIG. 2 and its description show an exemplary embodiment of the disclosed hybrid motor and do not intend to limit it in any way.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An electric hybrid outboard engine for an outboard motor, the outboard motor comprises a fuel engine and a shaft operably coupling the fuel engine to a propeller, the electric hybrid outboard engine comprises:
a hybrid motor that is configured to switch between an active mode and a passive mode, the hybrid motor in the active mode acts as a motor configured to drive the propeller using electrical energy stored in a battery, and the hybrid motor in the passive mode act as a generator configured to be driven by rotation of the shaft for charging the battery;
a transmission unit configured to operably couple the hybrid motor to the shaft; and
a control unit operably coupled to the hybrid motor and the transmission unit, wherein the control unit is configured to:
receive one or more parameters from one or more sensors, and
based on the one or more parameters, engage and disengage the hybrid motor to the shaft, engage and disengage the fuel engine to the shaft, and switch the hybrid motor between the active mode and the passive mode.

2. The electric hybrid outboard engine according to claim 1, wherein the hybrid motor is a brushless permanent magnet motor.

3. The electric hybrid outboard engine according to claim 1, wherein the electric hybrid outboard engine further comprises a shaft extension configured to couple the transmission unit to the propeller, wherein the transmission unit is configured to selectively drive the shaft extension by the hybrid motor or the fuel engine.

4. The electric hybrid outboard engine according to claim 1, wherein the one or more sensors comprises a speed sensor configured to detect a speed of a boat, wherein the control unit is configured to engage and disengage the hybrid motor to the shaft based on the speed of the boat.

5. The electric hybrid outboard engine according to claim 1, wherein the electric hybrid outboard engine further comprises a solar panel configured to be mounted to a roof of a boat, the control unit configured to charge the battery from renewable energy generated by the solar panel.

6. The electric hybrid outboard engine according to claim 4, wherein the one or more sensors further comprises a location sensor configured to detect a location of the boat, wherein the control unit is further configured to engage and disengage the hybrid motor to the shaft based on the location of the boat.

7. An outboard motor for a boat, the outboard motor comprises:
a fuel engine;
a shaft operably coupled to the fuel engine;
a propeller configured to be coupled to the shaft;
an electric hybrid outboard engine comprising:
a hybrid motor that is configured to switch between an active mode and a passive mode, the hybrid motor in the active mode acts as a motor configured to drive the propeller using electrical energy stored in a battery, and the hybrid motor in the passive mode acts as a generator configured to be driven by rotation of the shaft for charging the battery,
a transmission unit configured to operably couple the hybrid motor to the shaft, and
a control unit operably coupled to the hybrid motor and the transmission unit, wherein the control unit is configured to:
receive one or more parameters from one or more sensors, and
based on the one or more parameters, engage and disengage the hybrid motor to the shaft, engage and disengage the fuel engine to the shaft, and switch the hybrid motor between the active mode and the passive mode; and
a shaft extension operably coupling the transmission unit to the propeller, wherein the transmission unit is configured to selectively rotate the shaft by the hybrid motor or the fuel engine.

8. The outboard motor according to claim 7, wherein the hybrid motor is a brushless permanent magnet motor.

9. The outboard motor according to claim 7, wherein the one or more sensors comprises a speed sensor configured to detect a speed of the boat, wherein the control unit is configured to engage and disengage the hybrid motor to the shaft based on the speed of the boat.

10. The outboard motor according to claim 9, wherein the one or more sensors further comprises a location sensor configured to detect a location of the boat, wherein the control unit is further configured to engage and disengage the hybrid motor based on the location of the boat.

11. The outboard motor according to claim 7, wherein the electric hybrid outboard engine further comprises a solar panel configured to be mounted to a roof of the boat, the control unit configured to charge the battery from renewable energy generated by the solar panel.

12. A method for selectively propelling a boat using electricity or fuel, the boat comprising an outboard motor, the outboard motor comprises a fuel engine, a propeller, and a shaft operably coupling the fuel engine to the propeller, the method comprising the steps of:
providing an electric hybrid outboard engine comprising:
a hybrid motor that is configured to switch between an active mode and a passive mode, the hybrid motor in the active mode acts as a motor configured to drive the propeller using electrical energy stored in a battery, and the hybrid motor in the passive mode act as a generator configured to be driven by rotation of the shaft for charging the battery,
a transmission unit configured to operably couple the hybrid motor to the shaft, and
a control unit operably coupled to the hybrid motor and the transmission unit, wherein the control unit is configured to:
receive one or more parameters from one or more sensors, and
based on the one or more parameters, engage and disengage the hybrid motor to the shaft, engage and disengage the fuel engine to the shaft, and switch the hybrid motor between the active mode and the passive mode;
mounting the hybrid motor and the transmission unit to the shaft;
coupling a shaft extension to the transmission unit; and
coupling the propeller to the shaft extension, wherein the transmission unit is configured to selectively rotate the shaft by the hybrid motor or the fuel engine.

13. The method according to claim 12, wherein the hybrid motor is a brushless permanent magnet motor.

14. The method according to claim 12, wherein the method further comprises the steps of:
receiving a speed of the boat from a speed sensor;
comparing the speed of the boat with a threshold value; and
upon comparison, engage the hybrid motor to the shaft and disengage the fuel engine from the shaft.

15. The method according to claim 12, wherein method further comprises the steps of:
receiving a location of the boat from a location sensor;
inquiring the location with a list of predetermined locations; and
upon inquiring, engage the hybrid motor to the shaft and disengage the fuel engine from the shaft.

16. The method according to claim 12, wherein the electric hybrid outboard engine further comprises a solar panel configured to be mounted to a roof of the boat, wherein the method further comprises the steps of:
charging the battery from renewable energy generated by the solar panel.
